(19) United States
(12) Patent Application Publication
(10) Pub. No.: US 2007/0278762 A1
(43) Pub. Date: Dec. 6, 2007

(54) Bicycle sprocket structure

(76) Inventor: Wen-Yao Chang, Yuanhu Town (TW)

Correspondence Address: RABIN & BERDO, P.C., Suite 500, 1101 14th Street, N.W., Washington, DC, 20005, US

(21) Appl. No.: 11/442,426

(22) Filed: May 30, 2006

(51) Int. Cl. B62M 1/02

(52) U.S. Cl. 280/261

(57) ABSTRACT

A bicycle sprocket structure installs three pairs of embedding grooves at the periphery of an axle bushing of an axle base for installing brackets and latch members, and a plurality of latching points for latching the latch members are separated by 60 degrees. With the ratchets disposed on an internal side of the sprocket axle hole, the ratchet can be latched and linked with a pair of latch members in the shortest time, when a pedal is stepped clockwise to drive the sprocket to rotate clockwise after an idle run, so as to reduce the intermittent time and provide a smoother operation. Meanwhile, the number of latch members is increased, such that when the sprocket is latched and linked with the axle base, the remaining latch members constitute a multi-point contact support to enhance the stability of the operation and avoid damages to the related component due to a stress.

### BACKGROUND OF THE INVENTION

1. Field of the Invention

The present invention relates to a bicycle sprocket structure primarily used for a bicycle or a monocycle to provide better smoothness and stability for the operation of the sprocket.

2. Description of the Related Art

The major force for driving a bicycle resides on the collaboration of a sprocket and a hub of a wheel. With the design of a ratchet structure disposed at the internal periphery of each sprocket axle hole and a latch member installed at an axle base, the sprocket can be rotated clockwise by a chain, and the latch of the ratchet at the internal periphery of the axle hole with the latch member of the hub axle base is used for driving the wheels to rotate clockwise by the sprocket and the bicycle to go forward. If the sprocket is driven by the chain to rotate in a reverse direction, the unidirectional latch effect of the ratchet can prevent the link with the axle base of the axle, and thus causing an idle run of the sprocket to ensure the safety function of preventing a reverse rotation of the wheel.

However, the aforementioned sprocket structure still has the following shortcomings:

(1) Since the balls are installed at the sprocket between the axle base and the axle cover, it is necessary to use a special machine to seal the assembly, not only involving a complicated assembling process, but also requiring high equipment cost and virtually affecting the overall manufacturing cost.

(2) Since the sprocket is engaged and linked with the axle base, therefore if a pair of latch members at the periphery of the axle bushing of the axle base are used for the structural configuration and a user wants to step on the axle base and hub after an idle run of the sprocket, the latch members have to go through at least one route of the ratchet before the latch member is latched and linked with the ratchet. For example, if the ratchet in the axle hole of the sprocket is a 20-tooth ratchet (360÷20=18), the sprocket has to go through a route of 18 degrees before latching to the axle base and hub. If the ratchet in the axle hole of the sprocket is a 32-tooth ratchet, and 360÷32=11.25, then the sprocket has to go through 11.25 degrees for an intermittent time, and thus a longer intermittent time is produced and the smoothness of overall operation is affected virtually.

(3) Since the sprocket and axle base are linked by a pair of latch members to obtain a two-point support, the structural strength is obviously insufficient, therefore the latch member is worn out and damaged easily, and thus affecting the stability of the overall operation and providing a poor design.

### SUMMARY OF THE INVENTION

In view of the existing problems and shortcomings of the present bicycle sprocket structure, the inventor of the present invention based on years of experience in the related industry to conduct extensive researches and experiments, and finally developed the improved structure of the invention.

Therefore, the primary objective of the present invention is to provide a structural design to minimize the intermittent route and time for latching and linking the axle base and hub after an idle run of the sprocket in the reverse direction, and thus greatly enhancing the smooth operation of the sprocket.

Another objective of the present invention is to provide a structural design to obtain a multi-point contact support for the latch and link of the sprocket with the axle base, so as to enhance the structural strength and the operating stability and overcome shortcoming of damaging related components easily.

A further objective of the present invention is to provide a structural design, so as to simply the operating flow without requiring the use of a special machine to install the sprocket and the axle base and thus lowering the manufacturing cost.

To achieve the foregoing objectives, the structural design of the present invention is to substitute the balls disposed between the sprocket with the axle base and the axle cover by a ball bearing and increase the number of embedding grooves at the periphery of the axle bushing of the axle base for installing the bracket and latch member to three pairs. Such arrangement not only simplifies the assembling operation and positions and maintains the installation of each component, but also improves the smoothness and stability of the operation.

### BRIEF DESCRIPTION OF THE DRAWINGS

FIG. 1 is a schematic view of an operation of a preferred embodiment of the present invention;

FIG. 2 is an exploded view of an overall structure of a preferred embodiment of the present invention;

FIG. 3 is an exploded view of a ball bearing of a preferred embodiment of the present invention;

FIG. 4 is a schematic view of a structure of a preferred embodiment of the present invention;

FIG. 5 is a schematic view of a structural relation of a preferred embodiment of the present invention;

FIG. 6 is a schematic view of a structural relation of the operation run at an anticlockwise direction according to a preferred embodiment of the present invention;

FIG. 7 is a schematic view of a structural relation of the operation run at a clockwise direction according to a preferred embodiment of the present invention; and

FIG. 8 is a schematic view of a structural relation of another preferred embodiment of the present invention.

### DETAILED DESCRIPTION OF THE PREFERRED EMBODIMENTS

The above and other objects, features and advantages of the present invention will become apparent from the following detailed description taken with the accompanying drawing.

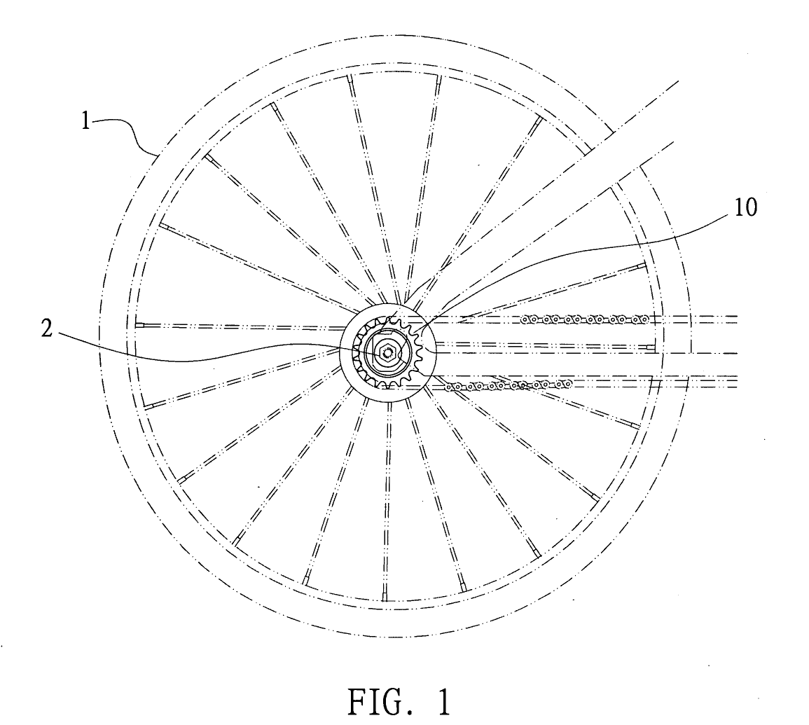

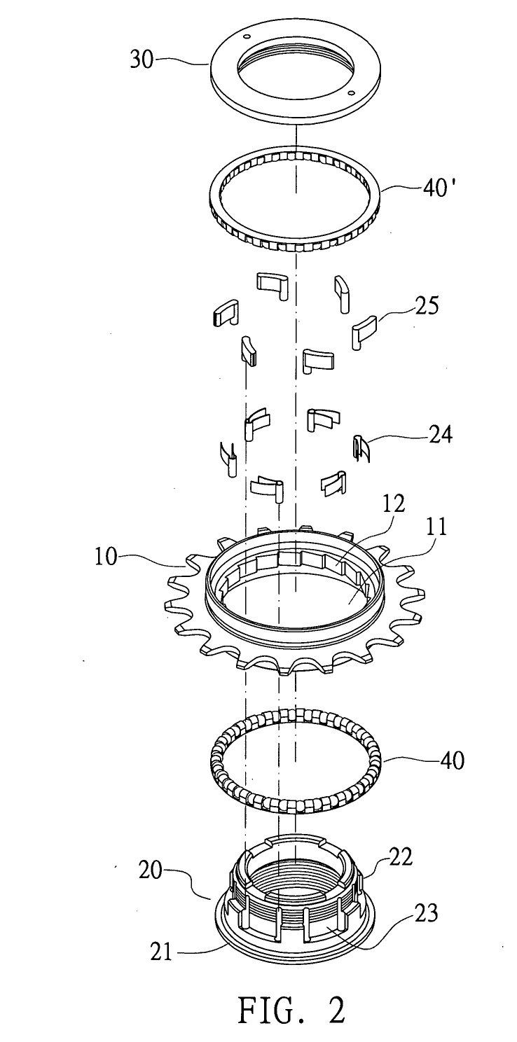

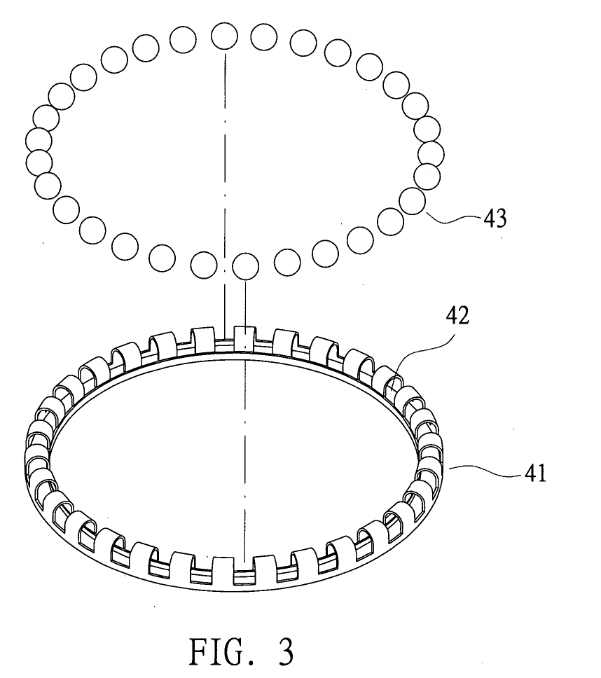

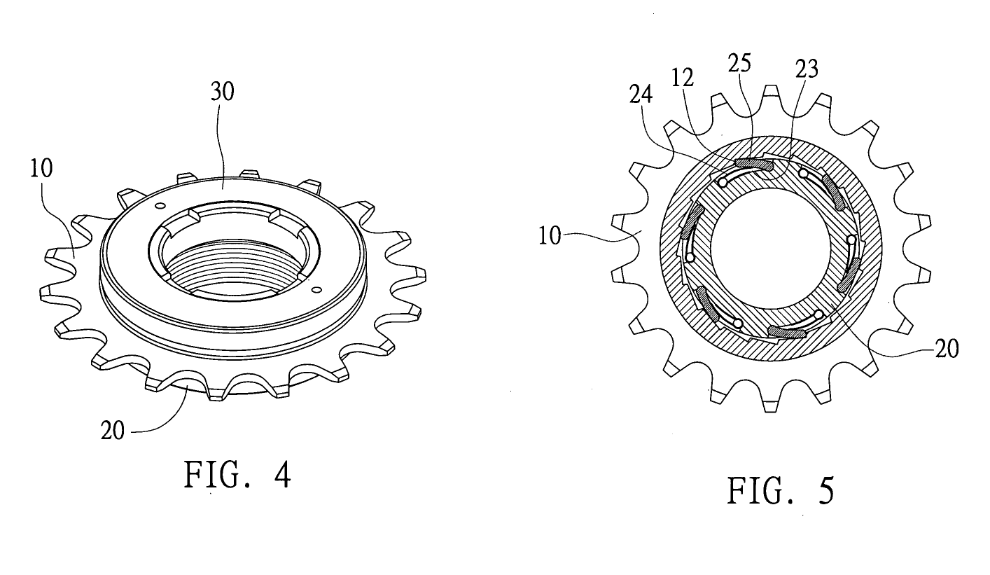

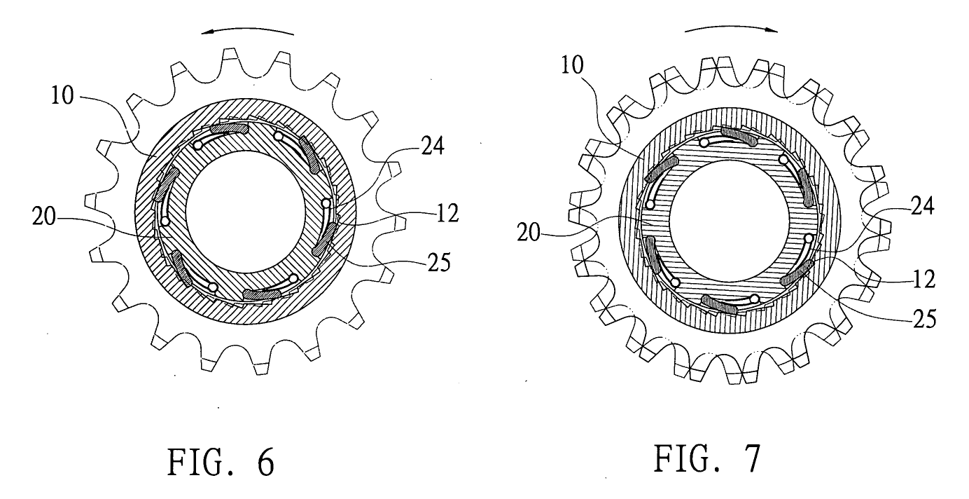

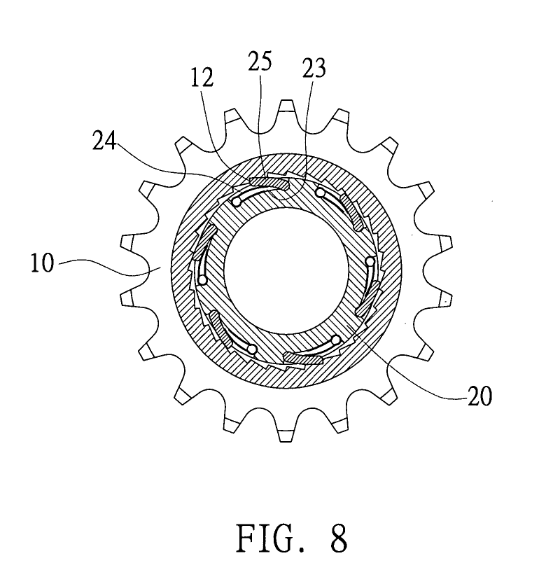

Referring to FIG. 1 for a schematic view of an application of the present invention, FIGS. 2 and 3 for the exploded views of the structural design, FIG. 4 for the schematic view of the structural relation, and FIG. 5 for the schematic view of structural relation according to a preferred embodiment of the present invention, the design of installing the hub 2 and the sprocket 10 of a bicycle wheel 1 uses an axle base 20 to go with an axle cover 30 as an assembling interface between the sprocket 10 and the hub 2, and the axle base 20 provides a base 21 of an expanded diameter and an axle bushing 22 of a reduced diameter and installs three pairs of embedding grooves 23 around the periphery of the axle bushing 22 proximate to the base 21 and uses a slot (not shown in the figure) disposed separately on both ends of the embedding groove 23 for embedding a bracket 24 and a latch member 25. The external side of the axle bushing 22 has screw threads, such that after the sprocket 10 is engaged with the axle bushing 22 of the axle base 20, the axle cover 30 is locked with the axle bushing 22 from another side to further fix and lock the sprocket 10. The internal side of the axle hole 11 of the sprocket 10 has a plurality of unidirectional ratchets 12, such that the brackets 24 and latch members 25 installed at the embedding grooves 23 which are disposed at the periphery of the axle bushing 22 of the axle base 20 constitute a latch and link relation. A balling bearing 40, 40′ is installed separately between the sprocket 10 and the base 21 of the axle base 20 and between the sprocket 10 and the axle cover 30 ball bearing 40, 40′, and the ball bearings 40, 40′ use a wearing-resisting material to produce a ring base 41 of a predetermined size, and the ring base 41 so produced has a predetermined number of ball channels 42. The balls 43 are embedded in the ball channels 42 to form a complete ball bearing 40, 40′, so as to provide a more convenient operation for the axle base 20, sprocket 10 and axle cover 30 and exempt the use of a traditional special machine according to the basic function architecture of the bicycle sprocket of the present invention. Referring to FIGS. 5 to 8 together with the foregoing structural design for the technical characteristics of the bicycle sprocket structure that can exempt the simple ball arrangement by using a ring base 41 to work with the embedded balls 43 to produce the ball bearing 40, 40′. Such arrangement not only simplifies the overall assembling process and saves manufacturing time, but also exempts the use of a special machine to greatly lower the overall manufacturing cost. On the other hand, the number of brackets 24 and latch members 25 installed between the axle base 20 and the sprocket 10 for defining the latching and linking relation is increased to three pairs (including six brackets 24 and six latch members 25, such that the stop points for latching the latch members 25 are separated from each other precisely by 60 degrees, and thus in the a 20-tooth sprocket 10 (as used in a preferred embodiment shown in FIG. 5) and 360 (degrees)÷20 (teeth)÷3 (pairs)=6 (degrees), the sprocket 10 just needs to go through a rotary route of 6 degrees to latch the latch member 25. For a 32-tooth sprocket 10 (as used in a preferred embodiment shown in FIG. 8) and 360÷32÷3=3.75, the sprocket 10 just needs to go through a rotary route of 3.75 degrees to latch the latch member 25 and achieve the transmission performance of the axle base 20 and hub 2. Compared with the prior art structure, the route is shortened by ⅔; in other words, when the sprocket 10 of the present invention is linked by a chain for an idle run if the pedal is stepped in a counterclockwise direction, and the sprocket 10 is driven by a clockwise rotating chain to rotate the axle base 20 and hub 2 clockwise, the sprocket 10 simply rotates 6 degrees or 3.75 degrees in a very short time, so as to latch a ratchet 12 disposed at an internal side of the axle hole 11 of the sprocket 10 with any pair of latch members 25 to produce a smoother transmission operation without causing any rough operation due to an excessively long intermittent time. Particularly, only one of the three pairs of the latch members 25 are linked with the sprocket 10, but the other two pairs of the latch members 25 still push the bracket 24 to fix the lateral side of the racket 12 of the sprocket 10, and thus the effect of a multi-point contact support can be achieved for scattering the latching and transmitting stress of the sprocket 10 exerted on the axle base 20 and preventing the stress from being centralized at the latched latch member 25, and maintaining an overall stability of the operation. The invention can appropriately enhance the overall structural strength to overcome the shortcoming of the related component being damaged easily.

In the structural design of the bicycle sprocket according to the present invention, the existing functional architecture and relation of the overall assembly remain unchanged, and a ring base is embedded to substitute the balls for improving the smooth rotation of the sprocket between the axle base and the axle cover and defining a ball bearing mode, so that no special machine is required for completing the overall assembly and thus effectively maintaining the fixing and positioning relation. Further, the number of embedding grooves installed at the periphery of axle bushing of the axle base for installing the brackets and latch members is increased to three pairs, and the stop points for latching the latch members are separated by an interval of 60 degrees to go with the design of the ratchets disposed at the internal edge of the sprocket axle hole, such that if the pedal is stepped for driving the sprocket to rotate clockwise after an idle run, the sprocket will be rotated to latch and link with a pair of latch members in the shortest time and give a smoother operation. In the meantime, the number of latch members is increased, so that when the sprocket latches and links the axle base, the remaining latch members constitute a multi-point contact support to improve the stability of the operation and avoid damages of the related components due to the stress, and overall speaking, the performance and application can be enhanced greatly.

What is claimed is:

1. A bicycle sprocket structure, designed for an assembly of a hub and a sprocket of a bicycle wheel, comprising:
an axle base and an axle cover, serving as an assembling interface for said sprocket and said hub, and said axle base including a base with an expanded diameter and an axle bushing with a reduced diameter;
an embedding groove, disposed around the periphery of said axle bushing and proximate to said base for embedding a bracket and a latch member by using a slot disposed separately on both sides of said embedding groove, and said axle bushing including a screw thread locking section disposed on an external distal end of said axle bushing for engaging said sprocket into said axle bushing of said axle base to lock said axle cover with said axle bushing from another side, so as to lock and fix said sprocket;
a plurality of unidirectional ratchets, disposed at the internal side of said axle hole of said sprocket for working together with a bracket and a latch member disposed at said embedding groove around the periphery of said axle bushing of said axle base to define a latching and linking relation; and
a plurality of balls, installed separately between said sprocket and said axle base as well as said sprocket and said axle cover for enhancing the smoothness of operating said ratchet; characterized in that:
the number of said brackets and latch members disposed around said axle bushing of said axle base for embedding said bracket and said latch member into said embedding groove is increased to three pairs, and stop points for latching said latch members are separated from each other by an interval of 60 degrees, and said ratchet disposed at an axle of said sprocket is a 20-tooth ratchet, so that when a pedal is stepped clockwise to rotate said sprocket clockwise after an idle run, said sprocket just needs to go through a route of 6 degrees to latch any pair of said latch members, so as to reduce the intermittent time and provide a smoother operation.

2. The bicycle sprocket structure of claim 1, further comprising:
a plurality of balls, installed between said sprocket and said axle base and between said sprocket and said axle cover; and
a ring base, for embedding a predetermined number of balls to define a ball bearing, thereby said ring base can be installed on said axle base, said sprocket and said axle cover more conveniently to effectively enhance a manufacturing efficiency.

3. A bicycle sprocket structure, designed for an assembly of a hub and a sprocket of a bicycle wheel, and comprising:
an axle base and an axle cover, serving as an assembling interface for said sprocket and said hub, and said axle base includes a base with an expanded diameter and an axle bushing with a reduced diameter;
an embedding groove, disposed around the periphery of said axle bushing and proximate to said base for embedding a bracket and a latch member by using a slot disposed separately on both sides of said embedding groove, and said axle bushing including a screw thread locking section disposed on an external distal end of said axle bushing for engaging said sprocket into said axle bushing of said axle base to lock said axle cover with said axle bushing from another side, so as to lock and fix said sprocket;
a plurality of unidirectional ratchets, disposed at the internal side of said axle hole of said sprocket for working together with a bracket and a latch member disposed at said embedding groove around the periphery of said axle bushing of said axle base to define a latching and linking relation; and
a plurality of balls, installed separately between said sprocket and said axle base as well as said sprocket and said axle cover for enhancing the smoothness of operating said ratchet; characterized in that:
the number of said brackets and latch members disposed around said axle bushing of said axle base for embedding said bracket and said latch member into said embedding groove is increased to three pairs, and stop points for latching said latch members are separated from each other by an interval of 60 degrees, and said ratchet disposed at an axle of said sprocket is a 32-tooth ratchet, so that when a pedal is stepped clockwise to rotate said sprocket clockwise after an idle run, said sprocket just needs to go through a route of 3.75 degrees to latch any pair of said latch members, so as to reduce the intermittent time and provide a smoother operation.
